(19) United States
(12) Patent Application Publication
(10) Pub. No.: US 2011/0163470 A1
(43) Pub. Date: Jul. 7, 2011

(54) SYSTEM FOR CREATING A DATA RECORD DESCRIBING A DENTAL PROSTHESIS PART, SYSTEM FOR THE PRODUCTION OF A DENTAL PROSTHESIS PART, METHOD AND DATA RECORD

(75) Inventor: Gerhard Weber, Purgen (DE)

(73) Assignee: Straumann Holding AG, Basel (CH)

(21) Appl. No.: 12/997,922

(22) PCT Filed: Jun. 15, 2009
(86) PCT No.: PCT/EP2009/004281

§ 371 Date: Feb. 4, 2011

(30) Foreign Application Priority Data
Jun. 17, 2008 (DE) 10 2008 028 748.2

(51) Int. Cl. A61C 13/00; G06F 7/00; B29C 35/08

(52) U.S. Cl. 264/16; 707/803; 425/174.4; 707/E17.044

(57) ABSTRACT

A system for creating a data record describing a dental prosthesis part, wherein the system comprises means with which a data record can be created, comprising: Entries regarding a plurality of elements that describe the surface or the shape of a dental prosthesis part, wherein for each entry one, two or more attributes are listed. The invention further relates to a corresponding system for producing a dental prosthesis part with a data record, corresponding methods and a corresponding data record.

### FIELD OF THE INVENTION

The invention refers to a system for creating a data record describing a dental prosthesis part, a system for the production of a dental prosthesis part, associated methods as well as a data record.

### BACKGROUND

For the production of dental prosthesis parts by means of CAD/CAM methods it is known to create a model of a dental prosthesis part on a computer, the shape of this dental prosthesis part being stored in a data record. By means of such a data record, a dental prosthesis part can be manufactured in automated form.

These data records describe the desired shape of the dental prosthesis part so that this desired shape can be produced by the respective production methods.

However, it is desirable for special dental prosthesis parts and for some production methods that besides the information concerning the shape other information is also usable.

### SUMMARY OF THE INVENTION

According to one embodiment of the invention, a system is provided for creating a data record having entries with respect to a plurality of elements, wherein these elements describe the shape or the surface of a dental prosthesis part. The elements can for instance be points or surface elements of the surface or also volume elements. For each such entry also one, two or more attributes are listed. Besides such entries with elements for which attributes are listed it is also possible that the data record comprises entries with respect to a plurality of elements for which, however, attributes are not listed. However, respective attributes can also be listed for all elements of the data record.

The system preferably comprises hardware and/or software components for designing a dental prosthesis part. For this purpose, a scanner can also be provided that can scan a model of a remaining tooth portion or a remaining tooth portion itself so that by this a data record is provided on the basis of which a data record describing the dental prosthesis part can be designed.

Furthermore, the system preferably comprises hardware and software components by means of which a plurality of elements can jointly be selected and certain attributes can jointly be associated to these elements. It is also possible that the allocation of attributes takes place in an automated manner in that a model is for instance automatically analyzed as to certain portions, and respective attributes are set automatically. Attributes can also be set manually in that when designing the dental prosthesis part in a computer-assisted manner respective portions of the dental prosthesis part are produced or provided with the respective attributes. Elements can also be selected for instance by means of a mouse or another operating device, and one or several attributes can then be allocated to these elements by respective instructions. For this purpose an area can be marked or selected in the visually shown model of the dental prosthesis part by a respective input device. The input could also be made by a selection of elements by means of certain criteria. The selection can also be made in a tabular illustration of the data record.

The attributes can for instance define a product accuracy, a material or the color for an element.

A system for producing a dental prosthesis part can for instance be a laser sintering device, however it can also be another device, such as generally a rapid prototyping device. Such a system can read-in a data record, wherein information concerning the attributes are also read in. Such attributes can be processed for controlling the production process. The system can for instance react with one or several predetermined actions on one or several attributes.

Preferably, attribute values are associated to other geometric elements, such as lines, wherein these geometric elements are used in the production process. Such other geometric elements can for instance be produced by a transfer of the shape defined by the surface elements to another geometric illustration required for production.

The data record is characterized in that not only a plurality of elements are entered that describe the surface or shape of the dental prosthesis part, but also by the fact that an attribute is listed for each element.

For instance more than 1,000, 5,000 or 10,000 entries can exist that describe elements. Attribute values are set for each such element.

Thus, entries can also exist in which no attributes are set. These can also be more than 1,000, 5,000 or 10,000 entries.

The data record can exist in the form of an stl format, a wmf format or any other format for storing a three-dimensional shape. Stl or wmf formats are detected by commercially available rapid prototyping devices.

The attributes are preferably stored in 2 bytes. The data to the elements in an entry can preferably occupy 48 bytes.

### BRIEF DESCRIPTION OF THE DRAWINGS

Preferred embodiments of the invention are explained by means of the enclosed Figures:

FIG. 1 is a graphical illustration of one example of a model of a dental prosthesis part composed of surface elements with attributes;

FIG. 2 is a schematic illustration of a section through a dental prosthesis part;

FIGS. 3a and 3b are schematic illustrations of the surface of a dental prosthesis part for use in a laser sintering process;

FIGS. 4a and 4b further illustrate schematically various surface elements of a dental prosthesis part during a production process; and

FIG. 5 is a schematic illustration of a system for generating a data recording and a system for producing a dental prosthesis part.

### DETAILED DESCRIPTION

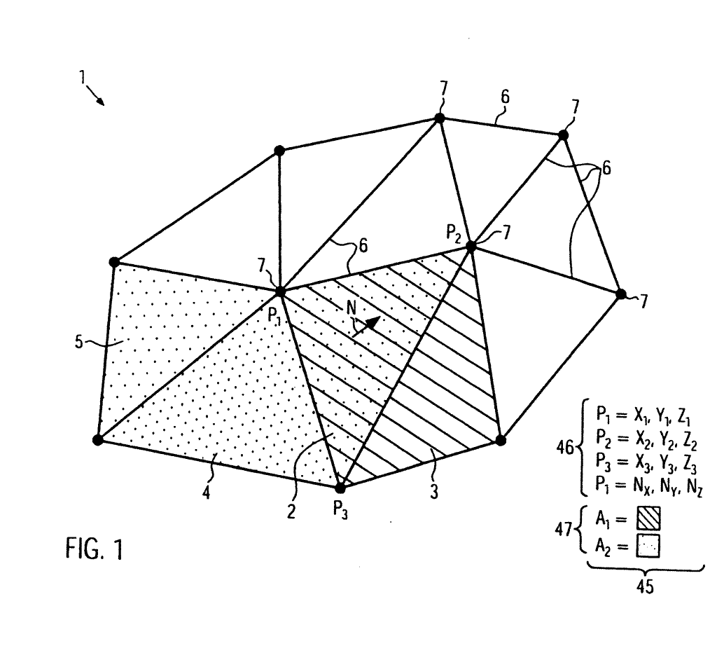

FIG. 1 shows a section of the surface of the model of a dental prosthesis part. The model is composed of a plurality of triangular surface elements. Adjoining surface elements have a common side 6 and the corners of the triangles carry reference numeral 7.

With a network of such surface elements any three-dimensional shape can be approximated or shown.

For storing this model, the data of the individual triangular surface elements is stored. This data for instance comprises the X, Y and Z coordinates of the three corner points. These are for surface element 2 e.g. points P1, P2 and P3.

Furthermore, a normal vector N with its X, Y and Z component is stored for this surface element. This normal vector can be standardized to 1. The normal vector usually serves for defining an orientation of the surface element, e.g. to distinguish the inner from the outer side of the surface.

If each of the X, Y, Z coordinates of the three corner points as well as the X, Y, Z component of the normal vector N is stored with 4 bytes each, a total of 48 bytes are required for this purpose. This part of the data of an entry in a data record is shown in FIG. 1 under reference numeral 46.

Particularly, the STL data formal shall be listed in the following:

| | |
|---|---|
| <STL file> | := <name><facet number><facet 1><facet 2> . . . <facet n> |
| <name> | := 80 bytes long file name; filled by blanks |
| <facet | := 4 bytes integer |
| number> | |
| <facet> | := <normal><corner 1><corner 2><corner 3><stuff bytes> |
| <normal> | := Nx, Ny, Nz; standardized to 1, 32 bit floating point |
| | numbers each |
| <corner> | := X, Y, Z; 32 bits floating point numbers each |
| <stuff bytes> | := 2 stuff bytes |

The file is therefore substantially composed of facets (triangular surface elements), wherein each facet has 50 bytes of memory space available, from which 48 bytes are used for data of the normal and the corner points and 2 bytes are not used. In these two bytes attribute values can be stored and this for each individual facet.

Different attributes A1, A2 can be set for the surface elements 2 to 5. This is shown in FIG. 1 by a cross hatching of the surface elements 2 and 3, which corresponds to attribute A1 and furthermore, the surface elements 2, 4 and 5 are shown in dotted form, which corresponds to the attribute A2.

As can be seen in FIG. 1, surface elements can comprise no attribute (in FIG. 1 in the upper half), they can have one of the two attributes A1 or A2, or also both attributes. More than two attributes A1, A1 can also be provided.

Each attribute can be stored in its own byte. However, a plurality of attributes can also be stored in one byte or several attributes can be distributed to several bytes, as for instance 3 or 4 attributes to two bytes.

The attributes for an entry in a data record are indicated in FIG. 1 by reference numeral 47. The entire entry carries reference numeral 45.

Such an entry 45 is provided for each surface element 2 to 5.

If none of the attributes is to be set for a surface element, the data field provided for this purpose remains empty (e.g. filled by zeros).

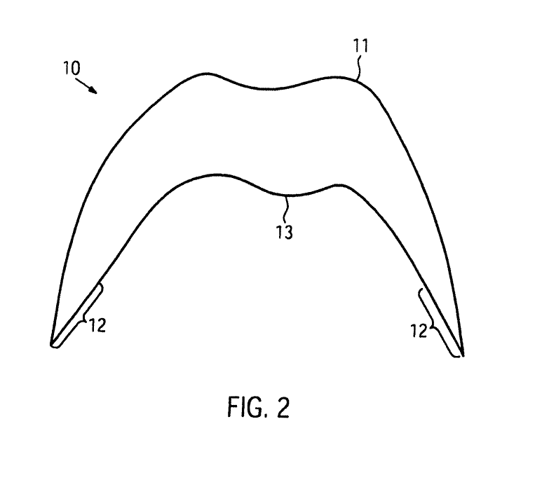

FIG. 2 shows a section through a dental prosthesis part 10. It has an outer side 11 and an inner side 13. On the lower end of the inner side 13 a section 12 is shown for which for instance an extremely high production accuracy is desired, since this portion finishes the inner portion 13 when setting the dental prosthesis part onto a remaining tooth. The area 12 is for instance designated as a preparation line.

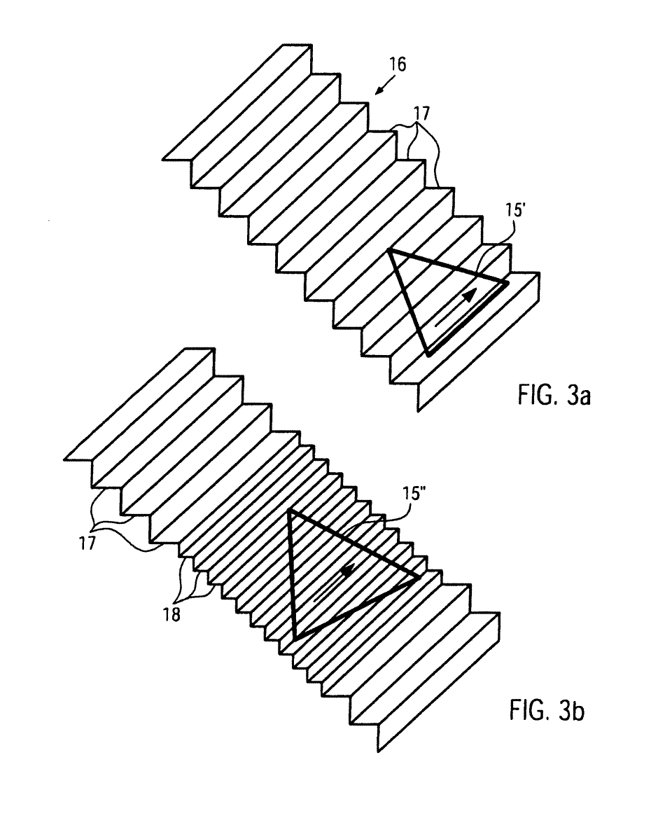

FIG. 3 shows two examples on how different product accuracies can be set in the laser sintering process. During laser sintering the workpieces usually have a step-like profile, which results from the layer-type application and solidification of the material to be sintered. These steps 17 are shown in FIG. 3a. Furthermore, a surface element 15′ with the normal is shown in FIG. 3a, as it could be situated in a respective data record.

As can be seen, the surface 16 formed by the steps differs from the shape determined by the surface element 15′. To reduce these deviations it is for instance possible to carry out the laser sintering process with thinner material applications so that smaller steps 18 result, as shown in FIG. 3b. In the area of the surface element 15″ the deviation of the real shape from the desired shape is significantly smaller than in FIG. 3a.

By use of the attributes, the production process during laser sintering can for instance be modified in that depending on the desired production accuracy differently high steps are generated or differently thick material applications take place that are subsequently solidified by laser sintering.

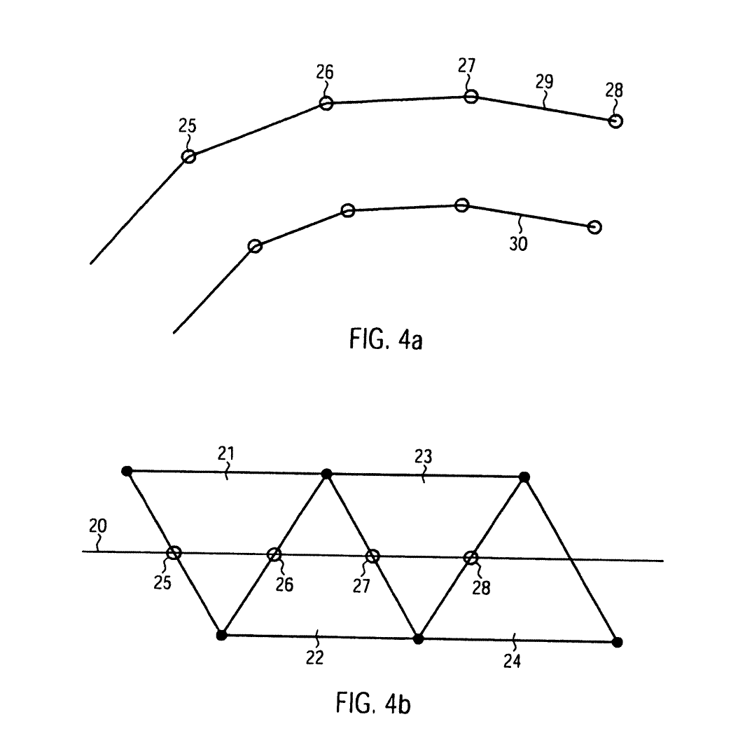

As shown in FIG. 3, sections along the triangles are required in the production process, wherein the sections can extend e.g. horizontally. The attributes associated to the surface elements can be processed in various ways. This shall be explained by FIG. 4.

FIG. 4a shows a section along a plane of the production process. The dental prosthesis part has an outer surface 29 and an inner surface 30 whose sections form straight line pieces with the drawing layer. The straight line pieces collide on the corner points 25, 26, 27, 28. The corner points 25 to 28 result from the section of a plane 20 with the triangular surface elements, as shown in FIG. 4b.

The attribute(s) of the surface element 21 can be associated to the line piece between the corner points 25 and 26. The attribute(s) of the surface element 22 can be associated to the line piece between the corner points 26 and 27, and the attribute(s) of the surface element 23 can be associated for the corner points 27 and 28, etc.

An attribute can also be associated to the corner points themselves. On the one hand it is conceivable that two overlapping corner points are provided instead of one corner point, wherein each corner point is associated to one line each. The attribute of the associated line is associated to each of these corner points. If, however, a corner point between two line pieces is associated to the two line pieces, either one of the two attributes can be selected, wherein respective predefined rules can be used, or a mean value can be formed, if the type of attribute values makes this possible.

Since the outer side 29 and the inner side 30 are defined by different surface elements, different attributes can be used in the same plane for the outer side and for the inner side.

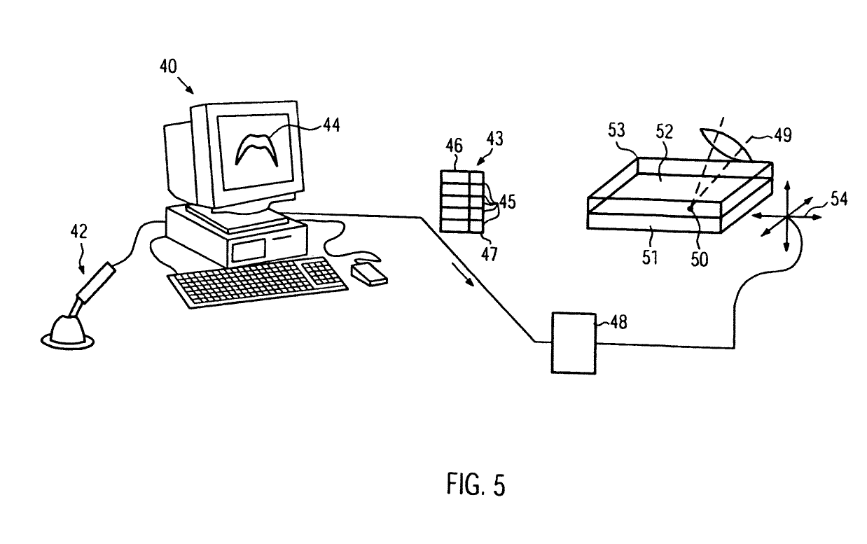

A computer system 40 is shown in FIG. 5 on the left side for producing a data record defining a dental prosthesis part. The model of such a dental prosthesis part is shown on the screen by reference numeral 44. The model 44 can be processed or generated by means of the keypad and the mouse or other input means. The system 40 can generate a data record from the model that can directly be used by the system 40 for producing a dental prosthesis part or that can also be sent (e.g. via an internet connection).

The system 40 further preferably comprises a scanner 42 by means of which a remaining tooth portion can be scanned. The data obtained thereby can serve as a basis for a model 44 of a dental prosthesis part.

The data record 43 comprises various entries 45, wherein each entry comprises a portion 46 that defines elements defining the surface or shape of a dental prosthesis part, as well as a part 47 that defines the attributes for such elements.

On the right-hand side of FIG. 5 a system for producing a dental prosthesis part is schematically shown. A laser sintering device is shown, in which a laser beam 49 is focused to a focus 50 and locally heats there, which leads to a solidification of the shapeless material located there. The material can for instance be liquid, powdery or granular and can be modified locally in structure by the laser and can thereby be solidified.

The focus 50 is located on the material surface 52, wherein further material 51 is applied onto this surface 52 in a layered manner and is there locally solidified by the laser beam 49. For this purpose the laser beam 49 or also a receiving trough 53 can be displaceable in all three spatial directions (see reference numeral 54). The laser beam 49 can also be movable along the surface 52 and the trough can be movable in a direction perpendicular thereto or vice versa.

By controlling the relative arrangement of the laser 49 with respect to the trough 53, parts shaped in any manner can be laser-sintered.

The material 51 used can for instance be gold dust or possibly a sinterable ceramic material.

A controller 48 is provided to control the relative arrangement of the laser 49 and the trough 53. This controller can read-in a data record 43, wherein during read-in the attribute data 47 is also used for producing the dental prosthesis parts. This relative control between the laser and the trough 53 can be influenced by the attributes.

The consideration of the attribute data can for instance lead to the fact that, as shown in FIG. 3b, a higher production accuracy is achieved for certain surface elements 15″ than for other regions.

1. System for creating a data record which defines a dental prosthesis part, wherein the system comprises an apparatus by which a data record can be created, the data record comprising:
entries with respect to a plurality of elements defining a surface or shape of a dental prosthesis part, and wherein one or more attributes are listed for each such entry.

2. System as claimed in claim 1, wherein the system comprises a computer with hardware and software for designing a dental prosthesis part.

3. System as claimed in claim 1, wherein the system comprises a scanner for scanning a model of a remaining tooth portion or for scanning a remaining tooth portion itself.

4. System as claimed in claim 1, wherein the system comprises software components, by which a plurality of the elements can jointly be selected and the attributes can jointly be associated thereto.

5. System as claimed in claim 1, wherein the attribute data define one or more of the following attributes: product accuracy, material, and color for the element.

6. System for producing a dental prosthesis part, comprising an apparatus by which a data record can be read in, the data record comprises entries with respect to a plurality of elements that define a surface or the shape of a dental prosthesis part, and wherein one or more attributes are listed for each such entry, and wherein a system component comprises a hardware component or software component which can process the attribute/s for the production process.

7. System as claimed in claim 6, wherein the system component is for analyzing the attributes for defining a production accuracy and/or a color of the dental prosthesis part and/or a material.

8. Method of creating a data record defining a dental prosthesis part, the data record comprising:
entries with respect to a plurality of elements defining a surface or shape of a dental prosthesis part, wherein for each such entry one or more attributes are listed.

9. Method as claimed in claim 8, wherein the data record is created from model data that define a dental prosthesis part, wherein the model data is previously read into a computer or is designed by a computer.

10. Method of producing a dental prosthesis part wherein a data record is read in, which data record comprises entries with respect to a plurality of elements defining a surface or shape of a dental prosthesis part, wherein for each such entry one or more attributes are listed, and wherein the attribute/s is/are processed for the production process.

11. Method as claimed in claim 10, wherein the attribute values of elements are associated to line elements and/or corner points used for the production process.

12. Data record comprising
entries with respect to a plurality of elements defining a surface or shape of a dental prosthesis part, wherein for each such entry one or more attributes are listed.

13. Data record as claimed in claim 12, wherein the data record exists in the form of an stl format, a wmf format or a format for storing a three-dimensional shape.

14. Data record as claimed in claim 12, wherein the attributes are stored in 2 bytes.

15. Data record as claimed in claim 12, wherein the entry comprises the X, Y and Z coordinates of three points of a triangle on the surface of the dental prosthesis part and the indication of a normal vector of the triangle.

16. Data record as claimed in claim 15, wherein the coordinates and indication occupy 48 bytes.

17. Data record as claimed in claim 13, wherein the attributes are stored in 2 bytes.

18. System as claimed in claim 6, wherein the apparatus includes a laser sintering apparatus for producing the dental prosthesis part.

19. Method as claimed in claim 10, wherein the apparatus includes a laser sintering apparatus for producing the dental prosthesis part.
